(19) United States
(12) Patent Application Publication
(10) Pub. No.: US 2019/0109889 A1
(43) Pub. Date: Apr. 11, 2019

(54) METHOD AND SYSTEM FOR CONTROLLING DATA TRANSMISSION

(71) Applicant: NOVUS4 LIMITED, Bury St Edmunds (GB)

(72) Inventors: Thomas HAIN, Cambridge (GB); Alexander AMSEL, Sheffield (GB); Jeremy STORR, East Norwich (GB); Humayun Munir Sheikh, Rattlesden (GB)

(21) Appl. No.: 16/086,819

(22) PCT Filed: Mar. 22, 2017
(86) PCT No.: PCT/GB2017/050812

§ 371 Date: Sep. 20, 2018

Related U.S. Application Data
(60) Provisional application No. 62/311,604, filed on Mar. 22, 2016.

(51) Int. Cl. H04L 29/08; H04L 29/06

(52) U.S. Cl. CPC H04L 67/10; H04L 51/08; H04L 65/1069; H04L 67/18

(57) ABSTRACT

The present invention relates to a method for controlling data transmission between parties. The method includes the steps of: creating a link between a first and second party; establishing a communications channel between the first and the second party based upon the link to transmit data associated with the first party; and transporting the data to the second party via the communications channel. The link is associated with parameters which govern the communications channel. A system for controlling data transmission is also disclosed.

### TECHNICAL FIELD

The present invention is in the field of data transmission. More particularly, but not exclusively, the present invention relates to controlling data transmission between parties.

### BACKGROUND

One of the fundamental underpinnings of the Internet is the ability to transmit or share data between parties. One of the original data transmission methods is electronic mail (email), where information is sent by an email client for the transmitting party, mediated by one or more email servers and retrieved by an email client for the recipient party.

The needs and requirements for data sharing have grown significantly since the development of email. Users now share information about themselves such as photographs and text to one or more contacts via social networks such as Facebook and Linkedin. Users or entities also share files through such services as WeTransfer, and share access to drives (where multiple files are organized and stored) via Google Drive and Dropbox. Collaborative working (involving multiple users contributing to a single file) is facilitated through Google Docs and collaborative systems such as Basecamp.

There is a desire for an improved system to enable data sharing or transmission between multiple parties.

It is an object of the present invention to provide a method and system for controlling data transmission which overcomes the disadvantages of the prior art, or at least provides a useful alternative.

### SUMMARY

According to a first aspect of the invention there is provided a method for controlling data transmission between parties, including:

a. Creating a link between a first and second party;
b. Establishing a communications channel between the first and the second party based upon the link to transmit data associated with the first party; and
c. Transporting the data to the second party via the communications channel;
wherein the link is associated with parameters which govern the communications channel.

The link may be dynamic.

The method may further include the step of creating a plurality of links between the first and second party.

The method may further include the step of assigning each of the first and second party a unique identifier, and utilizing the unique identifiers in creating the link. Each party may be only assigned one identifier. The identifier may be persistent. The method may further include the step of assigning further information about each party with their unique identifier.

Either of the first and the second party may initiate creation of the link.

Either of the first and the second party may initiate establishment of the communications channel.

Either of the first and the second party may initiate transportation of the data.

The method may further include the step of registering the data. Registering the data may include generating a unique identifier for the data. The unique identifier may include a hash key generated, at least in part, from at least a part of the data itself. The method may include the step of verifying the integrity of the data utilizing the hash key. The hash key may be generated from one or more elements of the data such that other elements of the data may be modified without affecting the validity of the hash key.

Each party may be associated with zero or more rights in relation to the data.

The parameters for the link may specify under what conditions a communications channel can be established. The conditions may include time and/or usage. The time conditions may include one or more of limited time periods, deadlines, invalid time period, and specific days of the week, month or year. The usage conditions may include the number of channels that can be established via the link and/or the amount of data that can be transferred in total.

The parameters for the link may specify the nature of the data that can be transported via a communications channel. The nature of the data may include one or more of specific data and type of data. The specific data may be identified within the parameter by a unique identifier for that data.

The method may further include the step of creating a second link between the second party and a third party; establishing a second communications channel between the first and the third party based upon the first and the second link to transmit data associated with the first party; and transporting the data to the third party via the second communications channel.

According to a further aspect of the invention there is provided a system for controlling data transmission between parties, including:

One or more processors configured to create a link between a first and second party;
One or more processors configured to establish a communications channel between the first and the second party based upon the link to transmit data associated with the first party; and
A communications system configured to transport the data from the first party to the second party via the communication channel;
wherein the link is associated with parameters which govern the communications channel.

Other aspects of the invention are described within the claims.

### BRIEF DESCRIPTION OF THE DRAWINGS

Embodiments of the invention will now be described, by way of example only, with reference to the accompanying drawings in which:

FIG. 1: shows a block diagram illustrating a system in accordance with an embodiment of the invention;

FIG. 2: shows a flow diagram illustrating a method in accordance with an embodiment of the invention;

FIG. 3: shows a block diagram illustrating a system in accordance with an embodiment of the invention;

FIG. 4: shows a flow diagram illustrating a data enrolment method in accordance with an embodiment of the invention;

FIG. 5: shows a flow diagram illustrating a link creation method in accordance with an embodiment of the invention;

FIG. 6: shows a flow diagram illustrating another link creation method in accordance with an embodiment of the invention;

FIG. 7: shows a flow diagram illustrating a communications channel establishment/creation method in accordance with an embodiment of the invention;

FIG. 8: shows a flow diagram illustrating a data transmission/transportation method in accordance with an embodiment of the invention; and

FIG. 9: shows a flow diagram illustrating a three-party data transmission method in accordance with an embodiment of the invention.

### DETAILED DESCRIPTION OF EMBODIMENTS

The present invention provides a method and system for controlling data transmission between parties.

The inventor has discovered that predefined links between parties can be used to govern the subsequent transmission of data between the parties. Furthermore, the existence of this system of links can be leveraged to provide information about relationships between the parties.

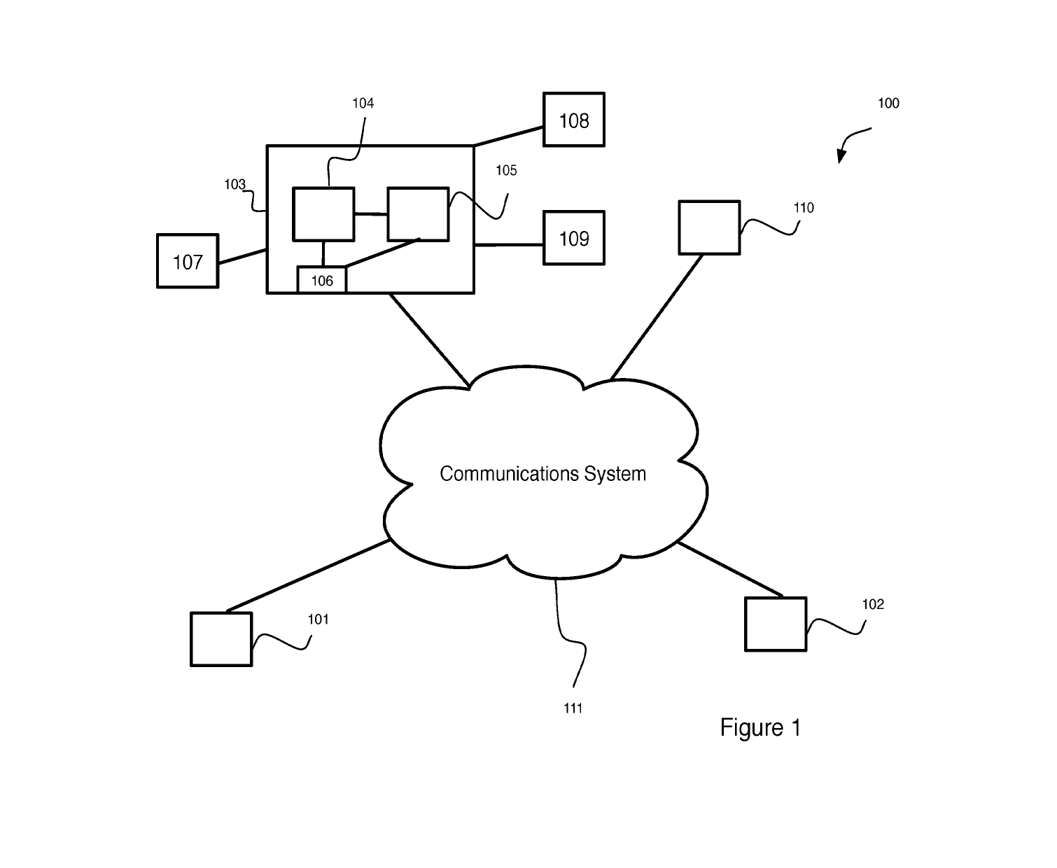

In FIG. 1, a system 100 in accordance with an embodiment of the invention is shown.

A first device 101 is shown. The first device 101 is associated with a first party. The first device 101 may be a computing device. In one embodiment, the first device 101 is a user device and the user of this device may be the first party. In an alternative embodiment, the first device 101 is a server device controlled by the first party.

A second device 102 is also shown. The second device 102 is associated with a second party. The second device 102 may also be a computing device. In one embodiment, the second device 102 is a user device and the user of this device may be the second party. In an alternative embodiment, the second device 102 is a server device controlled by the second party.

A server 103 is shown. The server 103 may include a first processor 104, a second processor 105, and a communications module 106.

The first processor 104 may be configured for creating a link between the first and second parties. The link may be created in response to a request from the first device 101. The link may be associated with one or more parameters, which in turn may be defined within the request.

The second processor 105 may be configured for creating a communications channel between the first and second parties for the purpose of transmitting data for the first party to the second party.

It will be appreciated that the first and second processor 104 and 105 may be the same processor.

The server 103 may be a web server.

In one embodiment, the first and second processors 104 and 105 may be distributed across a plurality of devices (for example, the first and second device 101 and 102) to facilitate a distributed architecture for the system 100.

A plurality of data stores 107, 108, and 109 are also shown. The data stores 107, 108, and 109 may be connected to the server 103, for example, via a communications system such as a network(s) or the Internet. A user data store 107 is shown. The user data store 107 may be configured to store information about parties. A data store 108 is shown. The data store 108 may be configured to store information about the location of data for the parties. A link data store 109 is shown. The link data store 109 may be configured to store information about the links between parties.

It will be appreciated that in a distributed architecture, the user, data, and link data stores 107, 108, and 109, respectively, may be distributed across a plurality of devices.

A data server 110 is shown. The data server 110 may be configured to store data, receive requests for data, and transmit data in response to the requests for data. In one embodiment of the system 100, data may be stored at a plurality of data servers.

A communications system 111 is shown. The communications systems 111 may be a network or combination of networks, such as the Internet. The communications system 111 may be configured for coordinating the transmission of data between the first device 101, the second device 102, the data server 110, and the server 103. The communications system 111 may be configured for transporting data for a first party from the data server 110 to the second party over a communications channel. Transportation of the data may be governed by one or more parameters associated with a link between the first and second parties.

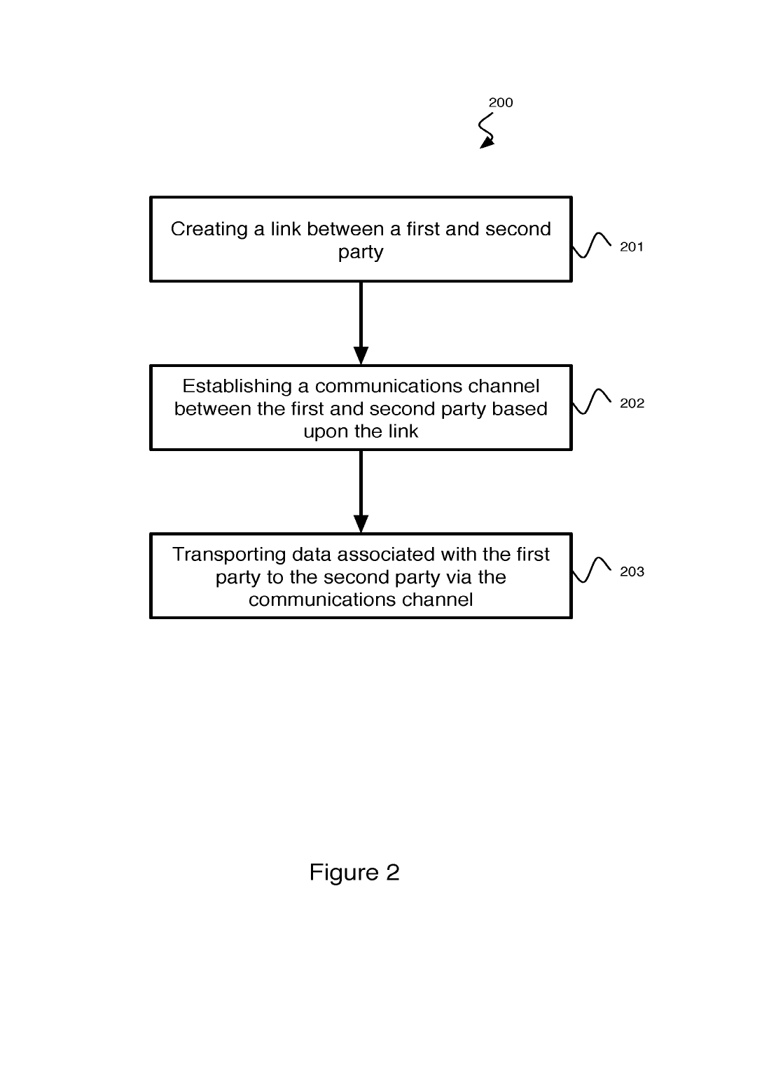

Referring to FIG. 2, a method for controlling transmission of data between a first party and a second party 200 in accordance with an embodiment of the invention will be described.

The first and second parties may be associated with unique identifiers. The unique identifiers may be private/public key pairs. The unique identifiers may be persistent for the party. Information related to the party may be associated with the unique identifier.

In step 201, a link is created between the first and second parties. The link may be created in response to a request from the first or second party. The request may originate, for example, at a first device 101 for the first party or second device 102 for the second party.

In one embodiment, the link may be created automatically, for example, from parameters governing a chain of links between multiple parties.

The link may be associated with one or more parameters for governing transport of data in connection with the link.

The one or more parameters may include conditions under which a communication channel can be established with the second party for the transportation of data of the first party via the link. The conditions may include conditions of timing and/or usage. For example, the timing conditions might specify transportation only during specified time periods, transportation by certain deadlines or not until after expiration of certain embargoes, transportation not to occur within specified time periods, or transportation only during specified days, days of the week, month or year; and the usage conditions might specify the maximum number of communication channels that can be established via the link.

The one or more parameters may specify the nature of data permitted to be transported across a communications channel created via the link. For example, it may restrict the data to specific data or types of data, or it may restrict transportation of specific data or types of data.

The link may be dynamic, that is, it may be modified. For example, by the first party, or by the system 100 in response to changing conditions.

In one embodiment, a plurality of links is created between the first and second parties.

Each link may be associated with a unique identifier.

In step 202, a communications channel is established between the first and second parties based upon the link to transport data associated with the first party. Either of first or second parties may initiate establishment of the communications channel. The parties may utilize the unique identifier for the link to establish the communications channel. The first party may identify the data using a unique identifier. The data may be stored in one of a plurality of data servers. The unique identifier may be constructed from the data, for example, via a hash function. In one embodiment, the hash function utilizes parts of the data to permit partial mutability of the data.

The first party may register the data by transmitting the location for the data to a server 103. Registration of the data may include generation and storage of the unique identifier for the data.

In step 203, data is transported to the second party via the communications channel. In one embodiment, the link is associated with a public/private key pair and these keys are used to facilitate transportation of the data.

The status of the transportation of the data may be stored as a transaction by the system 100.

In one embodiment, a second link is created between the second party and a third party. A second communications channel is established between the first and third party based upon the original link and the second link to transport the data associated with the first party. Data may then be transported to the third party via this communications channel. Parameters associated with the both the first and/or second links may govern this communications channel.

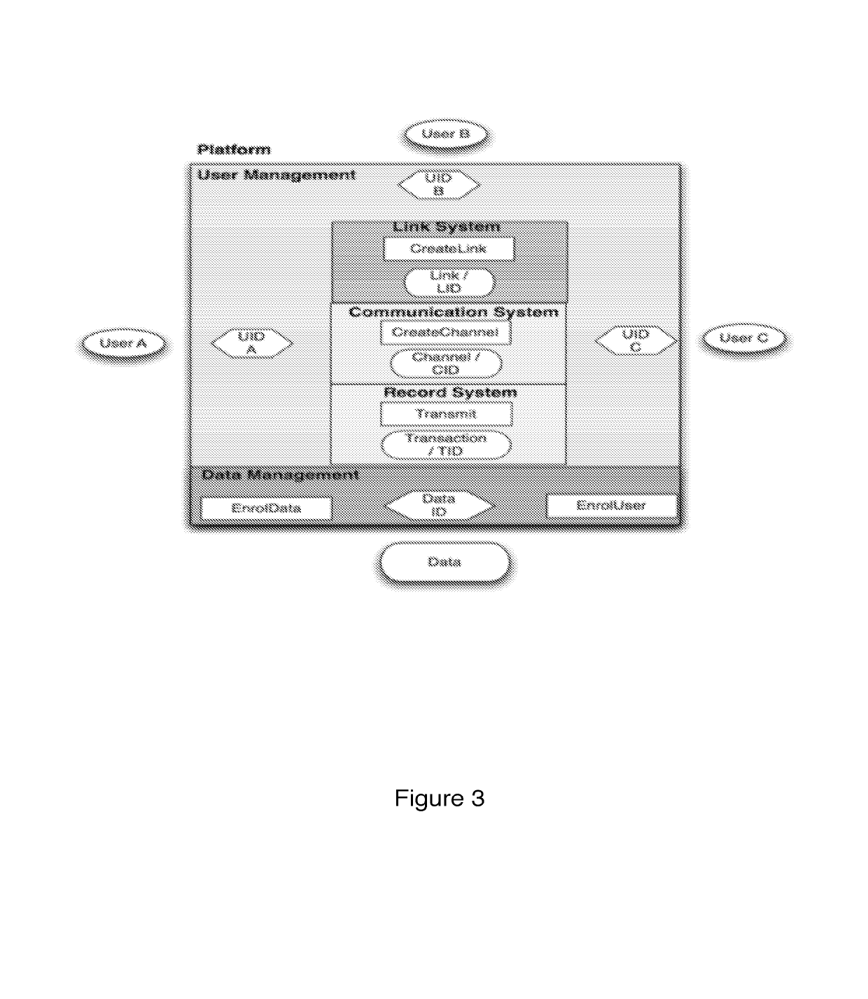

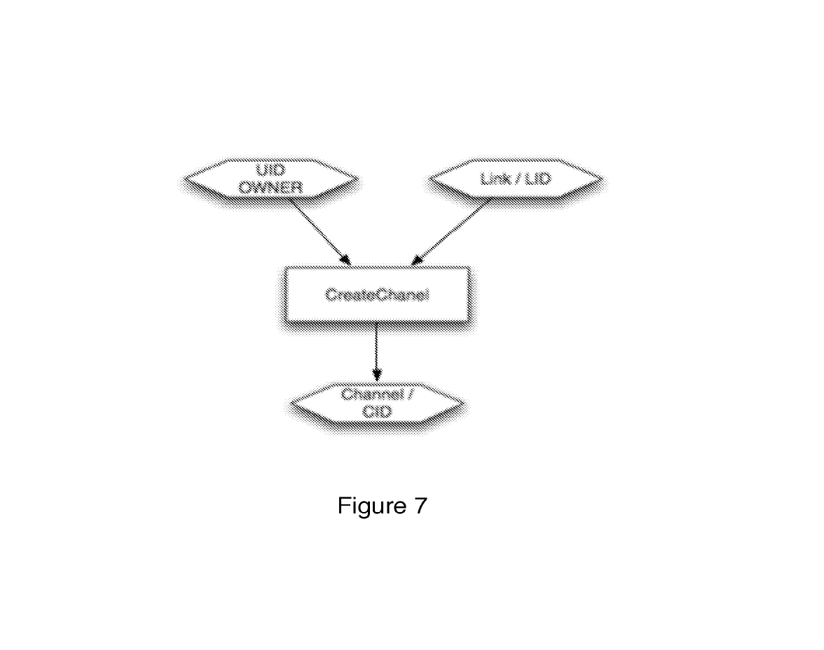

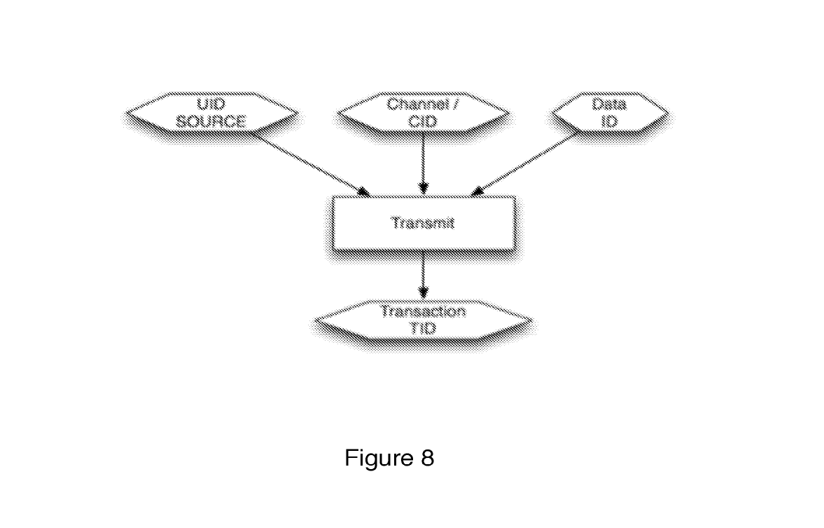

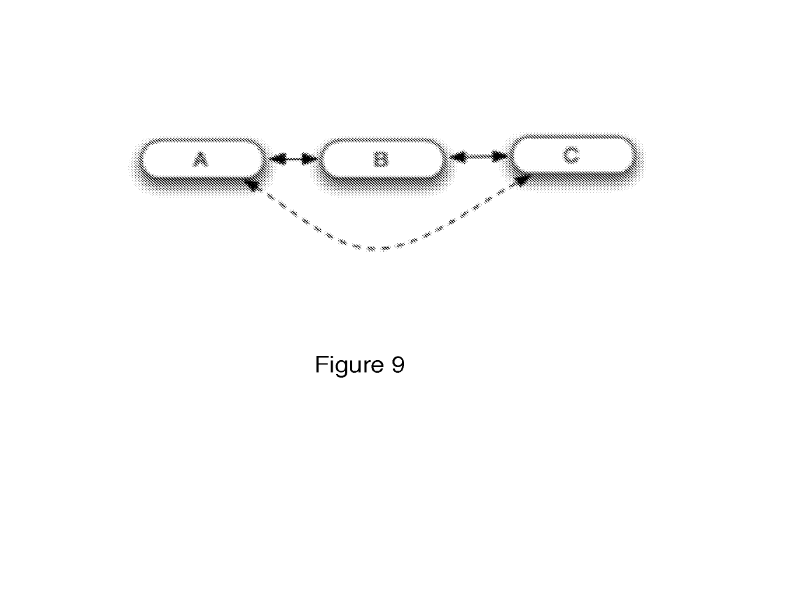

One embodiment of the present invention will now be described with reference to FIGS. 3 to 9.

This embodiment relates to a platform in which data can be transferred directly or via proxies between users. Data is to be considered in any form, regardless of its purpose or encoding.

The platform will be described with reference to FIG. 3. The platform consists of four main components: 1) a user and data system, 2) a link system, 3) a communication system and 4) record systems. These systems can be implemented in a single entity (e.g. a web server) but do not have to be-an alternative would be decentralized one or more of these systems. The following figure illustrates the key elements, which will be further described in the remainder of this document.

Users and data are shown outside of the platform in FIG. 3 as these are real physical entities. In the case of data, the data does not need to be kept inside the platform—but it could be.

In the platform all sharing is based on smart links between users. These links can be static or dynamic (e.g. programmatic) elements that can be delivered to a communication party. More than one link can exist between users and they can, but do not have to be data related. A non-data related link may just serve to signify connection with or membership of a group without the permission to communicate.

Entities

Entities are logical elements that make up the complete system of data sharing. Each of these entities will require a physical realization, but the exact nature of this can vary. For example, a channel may be encoded in the form of a unique key that allows the opening of a transmission mechanism of a third party, or a program that is delivered and has functionality to transmit data itself.

In one embodiment, there are six entities involved, however only five are active nameable components. The entity platform should be considered a description of a concept and is not required to be physical.

1. Platform

2. User

3. Data

4. Link

5. Channel

6. Transaction

These are described in greater details as follows:

Platform

The platform is a technology element that is responsible for automatic creation of identifiers. It is not a necessary element but should be understood as the collection of software that manages keys and activities, and therefore could be split into several subcomponents, further denoted as systems. As shown in FIG. 3, the platform consists of:

1. a user management system

2. a data management system

3. a link system

4. a communication system

5. a record system

Each of these could be implemented in different physical realizations. The functionality of these systems will be described later in this document.

User

User information is stored in the User management system.
A user has a unique id (UID) with which additional personal information is associated.
   These IDs may be public/private key pairs
One physical user should have only one UID, which is persistent through time.
Real users can create their everlasting identity by a registration process. The registration process is designed to ensure unique IDs.
Additional personal information for a user may include, but not be limited to:
   address information
   contact information
Such information can at the same time be considered data and given a unique data identity for the purposes of this system (see section below)
Users are the ones initiating processes. Such processes include:
   Creating or managing a link
   Initiating data transfer
Users can also be grouped:
A user group can have equal option to influence processes, as individual users would have.

The aspects discussed in this system should be unaffected whether the users in a group have equal rights on initiating processes or not.

The remainder of this description will refer to a user, but it will be appreciated that this may be a single user or a user group.

Data

Data is not as such to be stored inside the platform but exists in a wider context. It is the function of the data registration.

### Keys and Mutability

Data lives outside the platform but can be registered with the data management system. Upon registration data is assigned a unique ID that is equivalent to a hash key, which allows data integrity to be verified. (A hash is fixed length value that permits verification of data integrity but not data type). Therefore, by nature the hash key is firmly tied to a specific data item. However, the platform can also use hash keys which allow for mutable data. For example, first assume the data is in the format of a form, where the first elements somehow uniquely identify an event while the rest of the form is a description of the event. A hash function could then filter out the descriptive part of the document and only compute the hash on the header of the form. In that sense the document becomes mutable under certain hashes and associated hashing functions.

### Data Types

Data may be characterized into data types. Such type characterization may be universal (e.g. text, audio) or personalized to a user, or link. Personalization to a user may be simply a list of data types that a user holds. This personalized list of data types may be such that they imply the storage of a hashing function for verification of the data type. The personalized data type may only be allowed to be used by that user, therefore also encoding the user ID. A data type (and the associated hashing function) may also be associated with a link. Data type characterization may be encoded in the Data key. An example would be:

### DID (Data IDentifier)=

Data Hash Data Type

Data types may also be encoded in the data itself (through watermarking).

### Properties of Data

Data has a unique identifier (DID)
Data is associated with a user or a group of users. Each user or group of users may have specific rights to the data that will be recorded in the data management system in conjunction with the DID. Such rights may be thought of as rights to view, rights to store, rights to transmit, etc. The precise nature of such rights is not required to be specified here. It will be appreciated by those skilled in the art that any rights configurations that have to do with accessing data, statically or in a specific sequence (i.e. from one user to another) can be envisaged.

### Link

As noted above, a link specifies a relationship between users or groups of users for the purpose of the transfer of data. Links do not transfer data, they only permit the creation of channels to transfer data.

### Parameters

A link is parameterized. This means that a link is defined or controlled by parameters (see “Active or Passive” below). For example, a link may be directional thus allowing transfer from one user to another but not backwards. Other examples are that a user may transfer data only at certain times during the day, or only data of a certain type may be transferred.

### Realization

A link can be thought of as a set of properties associated with a key (a link identity, LID), or in other forms such as specific customized piece of software with a specific API for querying the link.

### Active or Passive

A link can be active or passive. A passive link is one where the pure existence of the link enables transfer of data (i.e. it is stateless and unconditional). An active link has additional parameters that determine if data can be transferred following the rules of this link. For example, in this embodiment, there may only be a time of day the link is valid, or for certain types of data at certain times, or the link may be provided with unlocking mechanisms. An example of an unlocking mechanism would that the link is furnished with a lock that requires a key. For example, upon creation of the link, the locking mechanism is attached. If a user wants to create a channel based on the link he also needs to provide the lock key.

### Link Chains

Links connecting a sequence of users are called link chains, e.g. user A is connected to user D through users B and then C. Link chains, like links, will always connect two users. These link chains will have their own unique link ID and may retain a reference to its constituent parts. The constituent parts may have multiple valid paths (therefore describing a link network). A link chain is formed by combining the links and call of a function to the link system.

### Properties

In one embodiment, a link has the following mandatory properties:
A creator of the link (users)
One or more controllers of the link (users)
A source group (users)
A target group (users)
A link identifier (LID)

The following elements are optional examples and allow to encode different capabilities of a link:
direction
data types or data identities (e.g. the link is only allowed for certain data types or one specific data element only)
properties (e.g. timing, creation destruction properties)
rules for allowing to create link chains. The link chaining is further explained in the example implementations.

### Creation

In one embodiment, a link has to contain source and target information. The process of link creation requires interaction with the user management system to determine if the users permit the link to be created.

A link can be created via:
information about the users to be linked
information about other links that should be chained (potentially augmented with additional constraints)

### Channel

A channel is a physical realization of a transfer mechanism to transport data. It can be realized in different ways, virtual or physical.

### Multiplicity

A channel can be associated with one or more links, and a link can have more than one channel.

### Realization

The channel can be realized in logical form, by defining a unique ID to be used in conjunction with an API that it provided by this platform or some other provider, or by providing a unique piece of software (an executable).

In order to transmit data across a channel, a special channel key may be required.

### Mechanism of Transport

In order to transport data the channels are linked with Transactions (below). The transaction system provides a transmission function that unlocks a channel for transmission.

### Transaction

Transactions are the instances of data transfer occurring between users (or groups thereof).

### Completeness

As transmission of data is a process that requires duration, a transaction may be recorded in terms of its completeness (e.g. initiated, 10% done, completed).

### Enabling a Transaction

A transaction is recorded as soon as a Transmit function is evoked.

In order to enable a transmission the initiator can use his user key, the data key and a link to use. The link will then provide a channel for transmission. Once the data is transferred through the channel, the transaction is recorded. Such recording may occur through secure traceable options (e.g. a hash recorded in a blockchain, a timestamped logging server).

Properties

In one embodiment, mandatory elements for the transaction are:
source user (or group)
target user (or group)
data specification (id)
channel identity
time and data

Optional elements may be:
completeness
link identity

### Key Processes

The platform as a whole provides key processes that ensure functioning of the system as a whole. There may be further auxiliary functionality required to ensure the practical functioning of such a platform. It will be appreciated by those skilled in the art of the details for the auxiliary functionality and as such this will not be described herein.

The key processes for the system are shown in FIG. 3:

1. Enrol a user (EnrolUser)
2. Enrol data (EnrolData)
3. Create a link (CreateLink)
4. Create a channel (CreateChannel)
5. Transmit data (Transmit)

Note that these are processes and should not be understood in functional form (i.e. with specific input and output parameters). The following sections give more details.

EnrolUser

Enrolling a user is the act of issuing a person with a unique ID. The process should ensure that every person only ever has one ID, however for the purpose of this system it is not required. Extensions to this functionality may include user group management.

A user ID can be implemented in form of a public/private key pair.

EnrolData

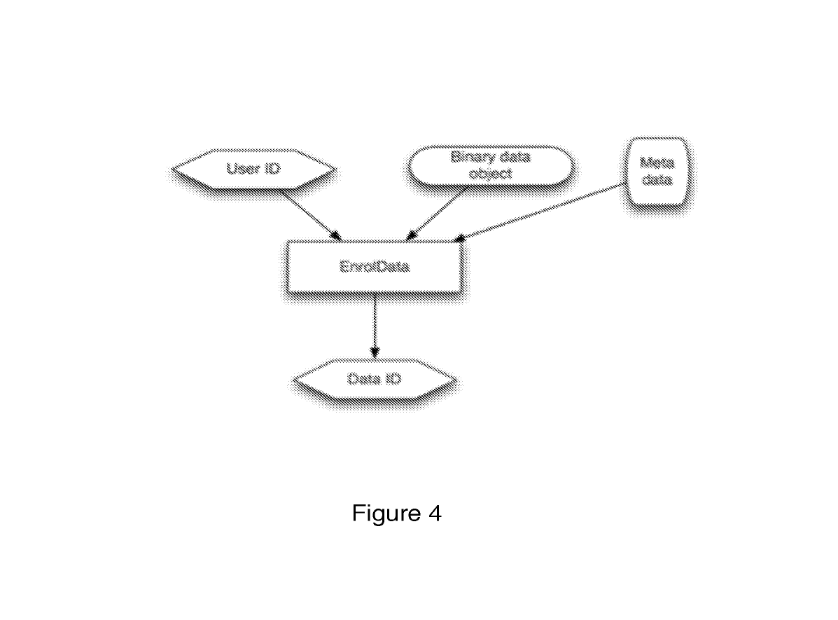

Referring to FIG. 4, data can be enrolled to the system in the same way that users can be, however all data will be associated with a user. FIG. 4 outlines the input and outputs of the process.

The optional metadata may be used to define data as being in a specific state, for example at a certain physical location. For the purpose of the workings of this system presented here the metadata is not required.

CreateLink

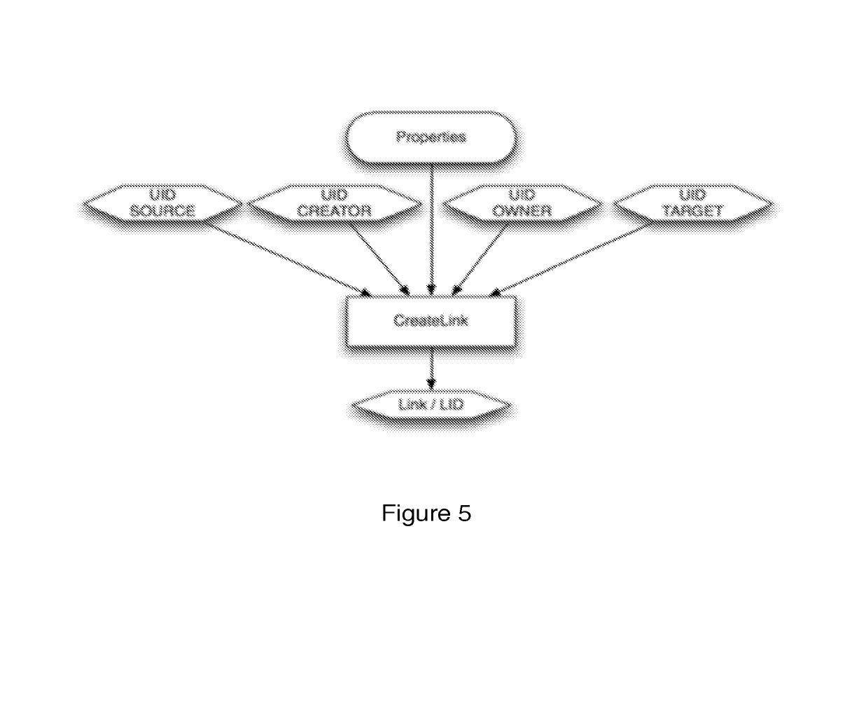

Creation of a link is shown in FIG. 5. To create a link requires user information. The link creation process needs to ensure that link is allowed to be created. For example, it needs to connect to the user management system to ask whether a link to them is allowed to be created. FIG. 4 illustrates the input/output relationship.

The input to link creation is an element called properties. This should be considered to be a set of properties. One of the options here could be a data ID (i.e. the link is created only for that data), or a data type. Further options are timing related, e.g. limited time periods, deadline times, invalid time periods, specific days of the week, month or year. Further options include usage counters, e.g. number of channels that can be created with that link. Links can also have expiry dates. If a link is created from link chains it inherits the chain properties with logical rules (e.g. and/or).

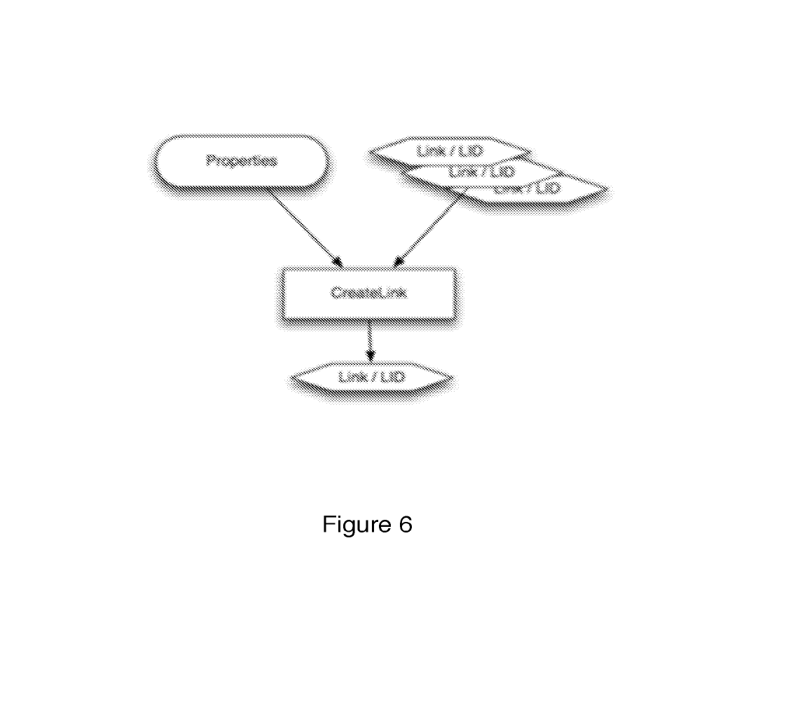

FIG. 6 shows an alternative link creation process. Rather than start from user information links can be created from already existing links. For example, user A and user B have a link, and user B and user C have a link. The link creation process may create a link between users A and C if the links have the appropriate permissions of chainability.

The precise rules for chainability are manifold and could be held flexible by providing a program that is user specific that determines whether chaining could occur. For example, such a chaining function could only allow chains if the conditions (properties—see above) are identical on both links, e.g. the same data type is allowed to be transferred. However timing properties could be logically combined, e.g. before 4 and after 2 pm implies a valid transfer time of 2-4 pm.

CreateChannel

As outlined above, a channel is simply a means to transport data. A channel will always be assigned to one or more links. Knowing the channel or equivalently, knowing the ID of the channel alone does not enable you yet to transmit. As the transmission is a function of the Record System further information is required.

Channel creation is based on links, and only those users controlling a link can instigate a transmission, or create a channel. Note that the controller of a link is not necessarily the same as the source of the link, but in many cases can be identical.

FIG. 5 illustrates link creation. The output can be an ID, or an executable, or an API call function.

Transmit

The ultimate objective of the platform is to transmit data. This is now possible by providing the source user ID, the data ID of the object to be transmitted, as well as an identification of the means of transport. The transport mechanism is a channel. FIG. 6 illustrates these relationships.

Hence the scenario for transmitting data between two users via the platform would include the following sequence of events:
1. Enrol Users A and B to get IDs
2. Enrol Data D to get its ID
3. Create a link between users A and B, e.g. only to transport data D within the next 10 min
4. Create a channel for the link via e.g. SMS transmission
5. User A obtains the channel and can, with his own ID, the channel ID and the data ID transfer the data to B.

### Platform Components

As outlined in FIG. 3, the platform consists of five key components that can be implemented in a single piece of software, or split between different realizations. Each one of these components can be executed in centralized or decentralized form.

User Management

The user management system is concerned with keeping a record of users, their personal data, as well as any data associated solely for them. Information of the users can be stored in centralized or decentralized manner as long as both yield verifiable entities. Its main task is to securely and reliably identify each person and associate it with a user. A user management system may record preferences about link creation for a user that can be passed to the link system.

Data Management

The data management system records unique data identifiers for all data transmitted within the system.

A data item can be either only one instance (version) or the data item and its mutations over time. A data ID may also be given to a group of data (a data type) subject to the users of the data management system and its own abilities to group and categorize data.

The role of the data management system is to store data identification, associate data with its owners, and potentially different rights, and to identify data that is in the system.

Link System

The function of the link system is to enable the creation of links that are permissible, identifiable, and configurable. In one embodiment, the platform may be required to store such links securely and should allow traceability of link creation (this may be implemented in a block-chain). The platform should further maintain which links are active and should provide information about links to authorized users. An advanced use of the platform would be to allow routing of information to people using different links to a person.

If traceability of link creation should be ensured or publicly available, decentralized storage of “link ledgers” is possible. Such ledgers may not give the link details, just store evidence of their creation record. This is essentially the function of so-called block-chains, and this technology can be used here.

The link system is required to interface with the user and data management systems.

Communication System

Communication is a distinct function that can be separated from the remainder of the platform in a simple fashion as long as the link system maintains a record of access to the channels.

The function of the communication system is to create channels for different data, depending on the type of data, the location the target audience, etc.

Record System

The function of the record system is to maintain a complete record of all transmission of data in the system in a safe and secure form, and to give access to such trace information.

This can be implemented centralized or decentralized, including in the form of a transaction ledger.

Several exemplary use cases for the platform will now be described:

### Verify a Document Source

### Use Case

User A receives a document from user B, and would like to know if it originates from user C.

### Realization

1. Users A, B and C enroll
2. Users A and B and B and C link up pairwise
3. User C creates a data ID for a document that allows passing on.
4. User C obtains a channel for its link to B
5. User C transmits the data via the channel to B.
6. User B has somehow transferred the data to user A
   It is not important how, but the end result is that User A now has the document ID, but not necessarily the associated transaction ID
7. User A receives a user id from user B
8. User A takes the document and User ID and asks the platform whether the data is genuine
9. The platform can now
   a. verify that the document ID is real and coincides with the data
   b. Identify the document ID and User ID from user C in the transaction ledger

One potential advantage of the use of the platform for this use case is that the data is not required to be held within the platform, it can be decentralized or distributed. A further advantage is the recording of the transaction history itself.

### Representing a Party

### Use Case

User B would like User A and User C to communicate with each other, although they have no relationship. B has links with A and links with C.

### Realization

1. Users A B and C enroll
2. Users A and B and B and C link up pairwise
3. User B creates a link derived from his links to A and C (see link creation)
4. User B can pass the new link to users A or C who then can create a channel and transmit data.

The link created in step 3 can include constraints that are harsher than those in existence in the links from step 2. This may reduce capability to a link for a time and a specific data element, or only the channel is passed on.

### Allow Two Parties to Exchange Specific Information of a Third Party

### Use Case

User B has given data to User A. User A should be allowed to exchange that information with User C.

### Realization

1. Users A B and C enroll
2. Users A and B and B and C link up pairwise
3. B creates a link derived from his links to A and C, specifically for the data item.
   Allow a to Verify that B and C have a Relationship

### Use Case

Party A and B and B and C have links. Party C wants to know if B has a link with A.

### Realization

1. Users A B and C enroll
2. Users A and B and B and C link up pairwise
3. User B takes his link ID specific his link to C, and passes it to user A.
   If necessary, B can create a duplicate temporary link for verification purposes only.
4. User A can verify the link validity (between B and A) to C indirectly through the link system interface, whilst not knowing about C or in such a way that only C can understand.

Two alternative exemplary implementations for the platform will now be described. The first describes a centralized system and the second a decentralized system:

### Example Implementation A—Central System (Simplified)

In this implementation, one type of data is transferable, links are bidirectional and can transport any kind of data.

### Data Types

User
UID
Data
DID
UID
Link (bidirectional/data agnostic/no constraints)
LID

| | |
|---|---|
| UID | UID |

Channel
CID

| | |
|---|---|
| UID | LID |

Transmission
TID

| | |
|---|---|
| CID | DID |

### Central Services

All storage is on central servers

| SYSTEM | DATA STORED | FUNCTIONS |
|---|---|---|
| User management | Stores lists of UIDs | Enrol User |
| | (public/private keys) | |
| Data management | Stores lists of Data | EnrolData (Data) |
| | elements DID −> (UID) | GetDataID (Data) |
| Link System | Stores lists of links | CreateLink (UID, UID) |
| | LID −> (UID, UID) | CreateBridgedLink |
| | | (LID, LID, . . .) |
| | | HasLink(UID, UID) |
| Channel System | Stores lists of CID −> | CreateChannel (UID, UID) |
| | (LID, UID) | |
| Record System | Stores lists of TID −> | Transmit (DID, CID) |
| | (CID, UID) | VerifyDataID (TID, DID) |

### Use Cases

### Verify a Document Source

User A receives a document from user B, and would like to know if it originates from user C.

1. User A as UID-A, user B has UID-B, User C has UID-C
2. User A creates link with user B by calling

LID-AB=CreateLink (UID-A, UID-B)

3. User B and user C link up by calling

LID-BC=CreateLink(UID-B, UID-C)

4. User C creates data ID for data element X

DID-CX=EnrolData (UID-C, X)

5. User C obtains a channel for its link to B

CID-BC=CreateChannel (LID-BC)

6. User C transmits the data via the channel to B

TID Transmit(CID-BC, UID-C, DID-CX)

7. TID and data element X gets transferred to user A somehow It is not important how!
8. User A gets data ID

DID=GetaDataiD(X)

### 9. Verification

There are two options
a. User A verifies data ID with transmission TID

VerifyDataID (TID, DID)

This function then checks if
1. DID is associated with TID
2. TID.CID.LID has DID.UID in one of the two fields. (the “.’ Signifies the element of the data type).
   b. User A verifies data ID with UID-B and UID-C

Check if DID.UID=UID-C and HasLink (UID-B, UID-C) is true

### Representing a Party

User B would like User A and User C to communicate with each other, although they have no relationship. B has links with A and links with C.
1. Users A B and C enroll, User A as UID-A, user B has UID-B, User C has UID-C
2. Users A and B and B and C link up pairwise
   LID-AB=CreateLink(UID-A UID-B)
   LID-BC=CreateLink(UID-B UID-C)
3. User B can create a link from his existing links to both A and C (see link creation)
   LID-AC=CreateBridgedLink (LID-AB, LID-BC)
   This function simply has to verify that the user id UID-B is in both links in this case. In more complex scenarios the function would need to check direction, data type etc for link creation. Furthermore the link could only be temporary, and for one purpose, or one data element.
4. User B can pass the new link to users A or C who then can create a channel and transmit data.
   This is similar to the first use case

### Allow Two Parties to Exchange Specific Information of a Third Party

User B has given data to User A. User A should be allowed to exchange that information with User C

In this case the Link also must hold data information.
1. Users A B and C enroll, User A as UID-A, user B has UID-B, User C has UID-C
2. Users A and B and B and C link up pairwise
   LID-AB=CreateLink (UID-A, UID-B)
   LID-BC=CreateLink (UID-B, UID-C)
3. Bridge the link with a specific data type
   LID-AC=CreateBridgedLink(LID-AB, LID-BC, Data Type)
   See previous use case. Here the link is created for one data type, or on data item.
4. Parties can how exchange data via the link using CreateChannel ( )

Allow A to Verify that B and C have a Relationship

Party A and Band B and C have links. Party C wants to know if B has a link with A.

### Realization

5. Users A B and C enroll, USer A as UID-A, user B has UID-B, User C has UID-C
6. Users A and B and B and C link up pairwise
   LID-AB CreateLink(UID-A, UID-B)
   LID-BC CreateLink(UID-B, UID-C)
7. LID-BC is passed from user B to user A. In case of a temporary link User B executes
   TempLink=MakeLinkCopy(LID-BC)
   and passes on TempLink
8. User A can verify the link validity by asking the Link system Haslink(LID-BC)

### Example Implementation B—Decentralized System (Simplified)

### Data Types

The data types remain the same as in example implementation A

### Decentralised Services

Decentralised services in the form of blockchain are useful to serve as storage for information that is visible to everyone and events can be logged, visible to everyone. A block-chain is a permissionless distributed database, that maintains a continuously growing list of transactional data records hardened against tampering and revision. A ledger is a record of public transactions.

For example, the Record System as described in the previous implementation may operate here a public ledger that can observe transactional data. The rest of the operations would remain identical in that case, the function call for creation of records would be to the public ledger.

Additionally, links may be publicly recorded in a public distributed ledger. In this case the fact that a link exists may be public and timestamped. The information about the nature of the links would remain encrypted. In the same way that double-spending of bitcoins are near impossible in a block-chain, the creation of links by a non-permitted party would be impossible.

### Use Cases

These remain identical to the previous implementation, as the storage has no impact on the function.

A potential advantage of some embodiments of the present invention is that increased and improved granular control can be provided to facilitate the sharing of data between parties. By utilizing predefined links associated with parameters, data can be shared with a high level of control without the requirement for a user to be involved in confirming or managing the transmissions process.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of applicant's general inventive concept.

1. A method for controlling data transmission between parties, including:
a. Creating a link between a first and second party;
b. Establishing a communications channel between the first and the second party based upon the link to transmit data associated with the first party; and
c. Transporting the data to the second party via the communications channel;
wherein the link is associated with parameters which govern the communications channel.

2. A method as claimed in claim 1, wherein the link is dynamic.

3. A method as claimed in any one of the preceding claims, further including the step of creating a plurality of links between the first and second party.

4. A method as claimed in any one of the preceding claims, further including the step of assigning each of the first and second party a unique identifier, and utilising the unique identifiers in creating the link.

5. A method as claimed in claim 4, wherein each party is only assigned one identifier.

6. A method as claimed in any one of claims 4 to 5, wherein the identifier is persistent.

7. A method as claimed in any one of claims 4 to 6, further including the step of assigning further information about each party with their unique identifier.

8. A method as claimed in any one of the preceding claims, wherein either of the first and the second party initiates creation of the link.

9. A method as claimed in any one of the preceding claims, wherein either of the first and the second party initiates establishment of the communications channel.

10. A method as claimed in any one of the preceding claims, wherein either of the first and the second party initiates transportation of the data.

11. A method as claimed in any one of the preceding claims, further including the step of registering the data.

12. A method as claimed in claim 11, wherein registering the data includes generating a unique identifier for the data.

13. A method as claimed in claim 12, wherein the unique identifier includes a hash key generated, at least in part, from at least a part of the data itself.

14. A method as claimed in claim 13, further including the step of verifying the integrity of the data utilising the hash key.

15. A method as claimed in any one of claims 13 to 14, wherein the hash key is generated from one or more elements of the data such that other elements of the data can be modified without affecting the validity of the hash key.

16. A method as claimed in any one of the preceding claims, wherein each party is associated with zero or more rights in relation to the data.

17. A method as claimed in any one of the preceding claims, wherein the parameters for the link specify under what conditions a communications channel can be established.

18. A method as claimed in claim 17, wherein the conditions include one or more of time and usage.

19. A method as claimed in claim 18, wherein the time conditions include one or more of limited time periods, deadlines, invalid time period, and specific days of the week, month or year.

20. A method as claimed in any one of claims 18 to 19, wherein the usage conditions include a number of channels that can be established via the link.

21. A method as claimed in any one of the preceding claims, wherein the parameters for the link specify the nature of the data that can be transported via a communications channel.

22. A method as claimed in claim 21, wherein the nature of the data includes one or more of specific data and type of data.

23. A method as claimed in claim 22, when dependent on claim 12, wherein the specific data is identified within the parameter by the unique identifier for that data.

24. A method as claimed in any one of the preceding claims, further including the step of creating a second link between the second party and a third party; establishing a second communications channel between the first and the third party based upon the first and the second link to transmit data associated with the first party; and transporting the data to the third party via the second communications channel.

25. A system for controlling data transmission between parties, including:
One or more processors configured to create a link between a first and second party;
One or more processors configured to establish a communications channel between the first and the second party based upon the link to transmit data associated with the first party; and
A communications system configured to transport the data from the first party to the second party via the communication channel;
wherein the link is associated with parameters which govern the communications channel.

26. A method and system for controlling data transmission between parties as herein described with reference to the Figures.
